(19) United States
(12) Patent Application Publication
(10) Pub. No.: US 2024/0034830 A1
(43) Pub. Date: Feb. 1, 2024

(54) POLYURETHANES WITH REDUCED COBALT EXTRACTABLES

(71) Applicant: Dow Global Technologies LLC, Midland, MI (US)

(72) Inventors: Adam L. Grzesiak, Midland, MI (US); Jacob W. Strother, Sweeny, TX (US); Nolan T. McDougal, Pearland, TX (US); Richard J. Keaton, Pearland, TX (US); David S. Laitar, Midland, MI (US); Mari S. Rosen, Houston, TX (US); Kaoru Aou, Lake Jackson, TX (US); Thomas P. Willumstad, Pearland, TX (US)

(21) Appl. No.: 18/013,046

(22) PCT Filed: Jul. 12, 2021
(86) PCT No.: PCT/US2021/041254

§ 371 Date: Dec. 27, 2022

Related U.S. Application Data
(60) Provisional application No. 63/053,059, filed on Jul. 17, 2020.

(51) Int. Cl. C08G 18/48; C08G 18/76; C08G 18/24; C08G 18/18; C08G 18/16; C08J 9/12

(52) U.S. Cl. CPC C08G 18/4816; C08G 18/485; C08G 18/4829; C08G 18/7671; C08G 18/244; C08G 18/1808; C08G 18/1833; C08G 18/165; C08J 9/125; C08G 2110/0083; C08G 2110/0008; C08J 2375/08; C08J 2205/06; C08J 2203/10

(57) ABSTRACT

Polyurethanes are made by curing a reaction mixture containing a polyether polyol that contains residues of a zinc hexacyanocobaltate catalyst complex. The reaction mixture contains certain chelating agents in small quantities. The amount of cobalt that is extractable from the polyurethane is reduced.

This invention relates to polyurethanes that have reduced cobalt extractables and to methods for reducing cobalt extractables from polyurethanes.

Polyurethanes are produced industrially in large quantities across the globe. Flexible polyurethane foams account for a large percentage of this production.

Polyurethane manufacturing is almost entirely based on the reactions of isocyanates with polyols, or with mixtures of polyols and water in the case of a foamed product. Polyether polyols are predominant, especially in flexible foam manufacturing.

Polyether polyols have long been manufactured in an anionic polymerization process using an alkali metal catalyst such as potassium hydroxide. More recently, however, some polyether polyol production has switched to using so-called “double metal cyanide” (DMC) catalysts such as zinc hexacyanocobaltate catalyst complexes. DMC catalysts offer some significant advantages over potassium hydroxide. Among these is a very low catalyst level. Because only very small amounts of catalyst are needed, it has been generally regarded as being unnecessary to remove catalyst residues from the product. This avoids costly catalyst deactivation and removal processes that are needed when using potassium hydroxide as the polymerization catalyst.

Polyether polyols produced using DMC catalysts therefore contain catalyst residues. Among these are compounds of cobalt and/or other transition metals. Polyurethanes made using these polyether polyols will also contain those residues.

At least some of these residues can be extracted with water, especially from polyurethane foams due to their open-celled structure and high internal surface areas. The metal(s) can leach when, for example, the foam is exposed to human fluids such as sweat or when the foam is laundered. Some jurisdictions have promulgated regulations limiting the amount of extractable metals contained in polyurethane foams.

Therefore, there exists a desire to reduce the amount of cobalt that is extractable from polyurethanes, in particular polyurethane foam made using polyether polyols that contain residues of DMC catalysts.

This can be accomplished by removing cobalt-containing DMC catalyst residues from the polyether polyol prior to manufacturing the foam. Various ways of doing this have been described previously. These methods include contacting the polyether with an oxidizing agent or an alkali metal compound to convert DMC catalyst residues to insoluble species, as described in U.S. Pat. Nos. 5,144,093 and 5,416,241, EP 370,705 and EP 556,261; producing the polyether in the presence of sepiolites and/or treating the polyether with sepiolites, followed by filtration, as described in US Published Patent Application No. 2003-0163006; agglomerating the catalyst residues with a polyacid, followed by filtration, as described in US 2004-0158032, EP0370705 & EP0556261.

Chelating agents such as EDTA (ethylene diamine tetraacetic acid) are known to sequester cobalt. In a process described in U.S. Pat. No. 5,248,833, EDTA or its salts are used to treat a polyol to remove DMC catalyst residues. This forms an insoluble precipitate that is removed by filtration.

These methods are all post-manufacturing or “finishing” methods that require additional purification steps to be added onto the polyether manufacturing process. Adding such a step undermines one of the main advantages of using DMC catalysts in the first place, i.e., reduced manufacturing costs due to the fact that finishing steps are not needed. Manufacturing savings are lost if one or more finishing steps become necessary.

In a medical application, EDTA and related compounds have been found to complex cobalt in the human body. The complexes thus formed are then eliminated through the urine, indicating these are easily extracted in an aqueous mammalian biological environment.

This invention is a method of producing a polyurethane, comprising the steps of

(I) forming a curable reaction mixture by combining ingredients comprising a) at least one polyisocyanate, b) a polyether polyol having a hydroxyl number of at most 250 mg KOH/g or a mixture of two or more polyether polyols each having a hydroxyl number of at most 250 mg KOH/g, wherein the polyether polyol or mixture of polyether polyols contains metal-containing residues of a zinc hexacyanocobaltate catalyst complex and c) 0.02 to 0.1 part by weight, per 100 parts by weight of b), of a chelating agent having a number average molecular weight of at most 3000 g/mol and at least two carboxylic acid groups and/or carboxylate groups, wherein the carboxylate group(s) are associated with a monovalent anion, and the carbonyl carbon atom of each carboxylic acid group and/or carboxylate group is not bonded directly to the carbonyl carbon atom of another carboxylic acid or carboxylate group and

(II) curing the curable reaction mixture to produce the polyurethane.

The invention is also a polyurethane foam made in accordance with the foregoing process. The foam is characterized in having a reduced amount of cobalt extractables compared to an otherwise like polyurethane made without the chelating agent. This effect is surprising, because cobalt chelated with some low molecular weight chelating agents is known to be extractable with water or other aqueous fluid in other systems, such as mammalian biological systems. Nonetheless, in the case of a polyurethane, the inclusion of certain amounts of the chelating agent during foam manufacturing has been found to reduce rather than increase the extractability of cobalt extractables.

The invention provides considerable advantages, in that no separation step is required to remove cobalt-containing catalyst residues from the polyurethane or from any polyether polyol used to manufacture the foam. Polyether polyols made using a zinc hexacyanocobaltate catalyst complex can be used in the polyurethane manufacturing process without performing a catalyst removal or other “finishing” step to remove cobalt-containing catalyst residues. Similarly, the polyurethane itself requires no post-treatment to remove those residues. Instead, the residues remain in the polyurethane, being more resistant to aqueous extraction.

The benefits of the invention are most pronounced when the polyurethane is a foam, particularly an open-celled foam. Foam products, due to their porosities and very high internal surface areas, in general are more susceptible to leaching than are non-cellular materials.

The polyurethane foam is made by curing a reaction mixture. The reaction mixture includes at least one polyisocyanate. In some embodiments each polyisocyanate has an isocyanate equivalent weight of at least 50 and up to 300 g/equivalent, as measured by titration methods such as ISO 14896:2009. Examples of useful polyisocyanates include m-phenylene diisocyanate, toluene-2,4-diisocyanate, toluene-2,6-diisocyanate, hexamethylene-1,6-diisocyanate, tetramethylene-1,4-diisocyanate, cyclohexane-1,4-diisocyanate, hexahydrotoluene diisocyanate, naphthylene-1,5-diisocyanate, 1,3- and/or 1,4-bis(isocyanatomethyl)cyclohexane (including cis- and/or trans isomers), methoxyphenyl-2,4-diisocyanate, diphenylmethane-4,4′-diisocyanate, diphenylmethane-2,4′-diisocyanate, hydrogenated diphenylmethane-4,4′-diisocyanate, hydrogenated diphenylmethane-2,4′-diisocyanate, 4,4′-biphenylene diisocyanate, 3,3′-dimethoxy-4,4′-biphenyl diisocyanate, 3,3′-dimethyl-4-4′-biphenyl diisocyanate, 3,3′-dimethyldiphenyl methane-4,4′-diisocyanate, 4,4′,4″-triphenyl methane triisocyanate, a polymethylene polyphenylisocyanate (PMDI), toluene-2,4,6-triisocyanate and 4,4′-dimethyldiphenylmethane-2,2′,5,5′-tetraisocyanate. Preferably the polyisocyanate is diphenylmethane-4,4′-diisocyanate, diphenylmethane-2,4′-diisocyanate, PMDI, toluene-2,4-diisocyanate, toluene-2,6-diisocyanate or mixtures thereof. Diphenylmethane-4,4′-diisocyanate, diphenylmethane-2,4′-diisocyanate and mixtures thereof are generically referred to as MDI, and all can be used. A polymeric MDI, which is a mixture of MDI and PMDI, is useful. Toluene-2,4-diisocyanate, toluene-2,6-diisocyanate and mixtures thereof are generically referred to as TDI, and all can be used.

The reaction mixture, prior to curing, contains one or more polyether polyols, each having a hydroxyl number of at most 250 mg KOH/g. The polyether polyol or polyol(s) contain cobalt-containing residues of a zinc hexacyanocobaltate catalyst complex. Suitable zinc hexacyanocobaltate catalyst complexes include those described, e.g., in U.S. Pat. Nos. 3,278,457, 3,278,458, 3,278,459, 3,404,109, 3,427,256, 3,427,334, 3,427,335, 5,470,813, 9,040,657, 9,556,309 and 10,233,284.

In general, at least one polyether polyol in the reaction mixture will have been produced partially or entirely using a zinc hexacyanocobaltate catalyst complex as a polymerization catalyst. If more than one polyether polyol is present in the reaction mixture, at least one or any higher number of them, including all of the polyether polyols, will have been produced partially or entirely using a zinc hexacyanocobaltate catalyst complex. Thus, the reaction mixture may contain only polyether polyols partially or entirely produced using a zinc hexacyanocobaltate catalyst complex, or may contain a mixture of one or more polyether polyols partially or entirely produced using a zinc hexacyanocobaltate catalyst complex and one or more other polyether polyols produced in the absence of a zinc hexacyanocobaltate catalyst complex. Such other polyether polyols may be prepared in an anionic polymerization process, such as, for example, by polymerizing in the presence of an alkali metal hydroxide (such as potassium hydroxide) and/or an alkali metal alkoxide. It is preferred that any polyether polyol made using a zinc hexacyanocobaltate catalyst complex will not have been treated to remove cobalt-containing catalyst residues.

The polyether polyol or polyols may contain, for example, at least 0.25 part per million by weight (ppm), at least 1 ppm, at least 2 ppm, at least 5 ppm or at least 10 ppm cobalt, based on the combined weight of polyether polyol(s) and cobalt. It may contain up to 200 ppm, up to 150 ppm, up to 100 ppm or up to 75 ppm cobalt, on the same basis. Cobalt content is conveniently measured by atomic absorption (AA) spectroscopy or inductively couple plasma atomic emission spectrometry (ICP-AES or simply ICP) or inductively coupled plasma mass spectrometry (ICP-MS).

The polyether polyol or mixture of polyether polyols may have, for example, an average hydroxyl number of 15 mg KOH/g to 250 mg KOH/g. The average hydroxyl number in some embodiments may be up to 200 mg KOH/g, up to 175 mg KOH/g, up to 100 mg KOH/g or up to 75 mg KOH/g. The average hydroxyl number in some embodiments may be at least 25, at least 30 or at least 40 mg KOH/g. Hydroxyl number is measured according to ASTM D4274-16 or equivalent method.

The polyether polyol or mixture of polyether polyols in some embodiments has an average nominal hydroxyl functionality of at least 1.8, at least 2.0 or at least 2.2. The average nominal functionality may be up to 6, up to 4, up to 3.5 or up to 3 in specific embodiments.

The polyether polyol(s) each may be a polymer of one or more alkylene oxides such as oxide, 1,2-propylene oxide, 1,2- or 2,3-butylene oxide and tetrahydrofuran. Of particular interest are poly(propylene oxide) homopolymers; random copolymers of propylene oxide and ethylene oxide in which the oxyethylene content is, for example, from about 1 to about 30% by weight; ethylene oxide-capped poly(propylene oxide) polymers which contain from 70 to 100% primary hydroxyl groups; and ethylene oxide-capped random copolymers of propylene oxide and ethylene oxide in which the oxyethylene content is from about 1 to about 30% by weight.

In a particular embodiment, the polyether polyol (component b) includes at least one random copolymer of propylene oxide and ethylene oxide having an oxyethylene content of 45 to 65% by weight, and which is made using a zinc hexacyanocobaltate catalyst complex and contains cobalt-containing residues of that catalyst complex. Such a polyether polyol may constitute, for example, at least 10%, at least 25% or at least 40% by weight of component b) and up to 100%, up to 80% or up to 65% by weight thereof.

The polyether polyol or mixture of polyether polyols may contain dispersed polymer particles such as polystyrene, styrene-acrylonitrile, polyolefin, polyurethane, polyurea, polyamide, polyurethane-urea, or polyhydrazide particles. Polyether polyols containing such dispersed polymer particles are commonly known as “polymer polyols” or “copolymer polyols”, and include the so-called “PIPA” (polyisocyanate polyaddition) polyols and “PHD” polyols. The weight of the dispersed polymer particles is counted toward the weight of the polyether polyol or mixture, and is counted toward the determination of hydroxyl number and hydroxyl equivalent weight.

The chelating agent has a molecular weight of at most 3000 g/mol. The molecular weight of chelating agents herein are formula weights for non-polymeric chelating agents, and weight average molecular weights (per gel permeation chromatography) for polymeric materials. The chelating agent contains at least two carboxylic acid (—COOH) or carboxylate (—COO⁻M⁺ where M is a monovalent anion) groups. The carbonyl carbon atom of each carboxylic acid or carboxylate group is not bonded directly to the carbonyl carbon atom of another carboxylic acid or carboxylate group, i.e., the chelating agent lacks H—O(O)C—C(O)O—H, H—O(O)C—C(O)⁻M⁺ and M⁺⁻O(O)C—C(O)⁻M⁺ units, the carbonyl carbons of the carboxylic acid and/or carboxylate groups being separated by at least one other atom.

In some embodiments, the carbonyl carbon of at least one carboxylic acid or carboxylate group is bonded to a nitrogen atom through a methylene group, i.e., the chelating agent contains one or more N—CH₂—C(O)OH or N—CH₂—C(O)O⁻M⁺ units, where the nitrogen is an amino or imino nitrogen.

In some embodiments, the chelating agent includes at least one H—O(O)C—CH₂—NR—CH₂—C(O)O—H, H—O(O)C—CH₂—NR—CH₂—C(O)⁻M⁺ and/or M⁺⁻O(O)C—CH₂—NR—CH₂—C(O)⁻M⁺ structure where R is an aliphatic group that may be substituted or unsubstituted, saturated or unsaturated. If substituted, R may be substituted with, for example, one or more carboxyl groups, one or more ether linkages, and/or one or more H—O(O)C—CH₂—NR—CH₂—C(O)O—H, H—O(O)C—CH₂—NR—CH₂—C(O)⁻M⁺ and/or M⁺⁻O(O)C—CH₂—NR—CH₂—C(O)⁻M⁺ structure

In some embodiments, the chelating agent includes at least one H—O(O)C—NR—R¹XH and/or M⁺⁻O(O)C—NR—R¹XH group where R is as before, X is oxygen, —NR—, —NH— or sulfur, and R¹ is an aliphatic, optionally substituted alkylene diradical. X is preferably oxygen. In these embodiments, the chelating agent may react with the polyisocyanate during the curing step to chemically bond the chelating agent into the polyurethane molecular structure.

Examples of nitrogen-containing chelating agents include ethylenediamine tetraacetic acid (EDTA), N-hydroxyethyl ethylenediamine N,N′,N′-triacetic acid (HEEDTA); 1,2-bis(o-aminophenoxy)ethane-N,N,N′,N′-tetracetic acid, tetraxetan ([CH₂CH₂NCH₂CO₂H]₄), ethylene diamine-N,N′-bis(2-hydroxyphenylacetic acid), ethylene diamine-N,N′-disuccinic acid (EDDS), egtazic acid, ethylene diamine N,N′-diacetic acid, glutamic acid, iminodiacetic acid, kainic acid, nitrilotriacetic acid and diethylene triamine pentaacetic acid (pentetic acid, DTPA), as well as partially and fully neutralized salts thereof wherein some or all of the acid protons are replaced with a monovalent anion.

Useful monovalent anions include alkali metals (particularly sodium and potassium), ammonium ion (NH₄), quaternary ammonium, phosphonium ion (PH₄) and quaternary phosphonium.

Other useful chelating agents include homopolymers and copolymers of acrylic acid and/or methacrylic acid (and/or the corresponding salts having a monovalent anion). Examples of these include acrylic acid homopolymers, methacrylic acid homopolymers acrylic acid/methacrylic acid copolymers, and copolymers of acrylic acid and/or methacrylic acid with one or more copolymerizable monomers such as ethylene, propylene, styrene, acrylonitrile and an acrylate or methacrylate ester such as methyl methacrylate, methyl acrylate, butyl methacrylate, butyl acrylate and the like, in each case having a number average molecular weight of up to 3000, as measured by GPC, as well as partially and fully neutralized salts thereof, where the anion is a monovalent anion as before.

Still other useful chelating agents are polycarboxylic acids such as citric acid, succinic acid and maleic acid, as well as partially and fully neutralized salts thereof, the anion being monovalent as before.

The chelating agent is provided in an amount of 0.02 to 0.1 parts by weight per 100 parts by weight of b). Smaller amounts provide little or no benefit. Surprisingly, larger amounts also provide little or no benefit and often increase cobalt extractables quite substantially. In some embodiments, at least 0.025 part is provided on the same basis.

The reaction mixture may contain one or more blowing agents if it is desired to form a cellular or microcellular polymer. Water is a preferred blowing agent, and may be present, for example, in an amount of 0.05 to 7.5 parts by weight per 100 parts of polyether polyol (component b). Other chemical and/or physical blowing agents can be used instead of or in addition to water. Chemical blowing agents react under the conditions of the polyurethane-forming step to produce a gas, which is typically carbon dioxide or nitrogen. Physical blowing agents volatilize under the conditions of the polyurethane-forming step. Suitable physical blowing agents include various low-boiling chlorofluorocarbons, fluorocarbons, hydrocarbons, hydrofluorinated olefins, hydrochlorofluorinated olefins and the like. Fluorocarbons, hydrocarbons, hydrofluorinated olefins and hydrochlorofluorinated olefins having low or zero global warming and ozone-depletion potentials are preferred among the physical blowing agents.

In addition, a gas such as carbon dioxide, air, nitrogen or argon may be used as the blowing agent in a frothing process.

In some embodiments of the invention, enough of the blowing agent is provided to the reaction mixture to produce a polyurethane foam having a foam density of 10 to 160 kg/m³. In particular embodiments, the foam density may be at least 16 kg/m³, at least 20 kg/m³ or at least 24 kg/m³ and up to 120 kg/m³, up to 80 kg/m³ or up to 64 kg/m³.

The reaction mixture may also contain one or more isocyanate-reactive materials, different from the polyether polyol(s) (component b), the chelating (component c) and the blowing agent. Examples include hydroxy-functional acrylate polymers and copolymers, hydroxy-functional polybutadiene polymers, polyether polyols, and various polyols that are based on vegetable oils or animal fats, in each case having a hydroxyl number of at most 250 mg KOH/gram. Isocyanate-reactive materials based on vegetable oils and/or animal fats include for example castor oil, hydroxymethyl group-containing polyols as described in WO 2004/096882 and WO 2004/096883, amide group-containing polyols as described in WO 2007/019063, hydroxyl ester-substituted fatty acid esters as described in WO 2007/019051, “blown” soybean oils as described in US Published Patent Applications 2002/0121328, 2002/0119321 and 2002/0090488, oligomerized vegetable oil or animal fat as described in WO 06/116456, hydroxyl-containing cellulose-lignin materials and hydroxyl-containing modified starches as well as the various types of renewable-resource polyols described in Ionescu, Chemistry and Technology of Polyols for Polyurethanes, Rapra Publishers 2005.

Another useful class of optional isocyanate reactive materials is crosslinkers, i.e., polyols and aminoalcohols that contain at least three isocyanate-reactive groups per molecule and have a hydroxyl number of greater than 250 mg KOH/g, preferably from about 350 to about 1870 mg KOH/g. These materials may have up to 8 or more isocyanate-reactive groups per molecule. They most typically include no more than one primary or secondary amino group, and two or more primary or secondary hydroxyl groups. Examples of isocyanate-reactive materials of this type include diethanolamine, triethanolamine, di- or tri(isopropanol) amine, glycerin, trimethylolpropane, pentaerythritol, and various polyester and polyether polyols that have at least three hydroxyl groups per molecule and a hydroxyl number of greater than 250 mg KOH/g.

Another class of suitable isocyanate-reactive materials includes chain extenders, which for the purposes of this invention means a material having exactly two isocyanate-reactive groups per molecule and a hydroxyl number greater than 250 mg KOH/g, especially 449 to 1810 mg KOH/g. The isocyanate reactive groups are preferably hydroxyl, primary aliphatic or aromatic amine or secondary aliphatic or aromatic amine groups. Representative chain extenders include ethylene glycol, diethylene glycol, triethylene glycol, 1,2-propylene glycol, 1,3-propylene glycol, 1,4-butane diol, 1,6-hexane diol, neopentyl glycol, dipropylene glycol, tripropylene glycol, poly(propylene oxide) diols having a hydroxyl number greater than 250 mg KOH/g, cyclohexanedimethanol, poly(ethylene oxide) diols having a hydroxyl number greater than 250 mg KOH/g, aminated poly(propylene oxide) diols having a hydroxyl number greater than 250 mg KOH/g, ethylene diamine, phenylene diamine, diphenylmethane diamine, bis(3-chloro-4-aminophenyl)methane and 2,4-diamino-3,5-diethyl toluene. A mixture of chain extenders may be used.

Optional isocyanate-reactive materials, if present at all, preferably are present in small quantities, such as up to 25 parts by weight, up to 15 parts by weight, up to 10 parts by weight or up to 5 parts by weight, per 100 parts by weight of the polyether polyol(s) (component b). The optional isocyanate-reactive materials may be absent entirely.

The reaction mixture preferably contains at least one urethane catalyst, by which is meant a catalyst for a reaction of an alcohol with an isocyanate, a reaction of water with an isocyanate, or both. Examples of urethane catalysts include:
i) tertiary amines such as trimethylamine, triethylamine, N-methylmorpholine, N-ethylmorpholine, N,N-dimethylbenzylamine, N,N-dimethylethanolamine, N,N,N′,N′-tetramethyl-1,4-butanediamine, N,N-dimethylpiperazine, 1,4-diazobicyclo-2,2,2-octane, bis(dimethylaminoethyl)ether, triethylenediamine and dimethylalkylamines where the alkyl group contains from 4 to 18 carbon atoms;
ii) cyclic amidines as 1,8-diazabicyclo(5.4.0)undec-7-ene and 1,5-diazabicyclo(4.3.0)non-5-ene;
iii) tertiary phosphines such as a trialkylphosphine or dialkylbenzylphosphine;
iv) metal salts of strong acids, such as ferric chloride, stannic chloride, stannous chloride, antimony trichloride, bismuth nitrate and bismuth chloride; strong bases, such as alkali and alkaline earth metal hydroxides, alkoxides and phenoxides;
(v) alcoholates or phenolate of various metals, such as Ti(OR)₄, Sn(OR)₄ and Al(OR)₃, wherein R is alkyl or aryl, and the reaction products of the alcoholates with carboxylic acids, beta-diketones and 2-(N,N-dialkylamino)alcohols;
(vi) alkaline earth metal, Bi, Pb, Sn or Al carboxylate salts such as tin dioctoate; (vii) tetravalent tin compounds, and certain tri- or pentavalent bismuth, antimony or arsenic compounds and
(viii) tin mercaptides and/or mercaptoacetates.

Catalysts may be present in an amount of 0.0001 to 5 parts by weight per 100 parts by weight of the polyether polyol(s) (component b).

One or more surfactants may be present, particularly when a blowing agent is present in the curable reaction mixture. A surfactant can help to stabilize the cells of the curable reaction mixture during the curing step as gas evolves to form bubbles. Examples of suitable surfactants include alkali metal and amine salts of fatty acids, such as sodium oleate, sodium stearate, diethanolamine oleate, diethanolamine stearate, diethanolamine ricinoleate and the like; alkali metal and amine salts of sulfonic acids such as dodecylbenzenesulfonic acid and dinaphthylmethanedisulfonic acid; ricinoleic acid; siloxane-oxyalkylene polymers or copolymers and other organopolysiloxanes; oxyethylated alkylphenols (such as Tergitol NP9 and Triton X100, from The Dow Chemical Company); oxyethylated fatty alcohols such as Tergitol 15-S-9, from The Dow Chemical Company; paraffin oils; castor oil; ricinoleic acid esters; turkey red oil; peanut oil; paraffins; fatty alcohols; dimethyl polysiloxanes and oligomeric acrylates with polyoxyalkylene and fluoroalkane side groups. These surfactants are generally used in amounts of 0.01 to 3 parts by weight per 100 parts by weight of the polyether polyol(s) (component b). Organosilicone surfactants are generally preferred types. Examples of commercially available surfactants that are useful include Dabco™ DC2585, Dabco™ DC5043 and Dabco™ DC5180 surfactants, available from Evonik, Niax™ U-2000 surfactant, available from Momentive, and Tegostab™ B 8681, Tegostab™ B4351, Tegostab™ B8631, Tegostab™ B8707 and Tegostab B8715 surfactants, available from Evonik.

One or more fillers may also be present in the reaction mixture. Examples of suitable fillers include kaolin, montmorillonite, calcium carbonate, wollastonite, talc, high-melting thermoplastics, glass, fly ash, carbon black, titanium dioxide, iron oxide, chromium oxide, azo/diazo dyes, phthalocyanines, dioxazines, colloidal silica and the like. The filler may impart thixotropic properties. Fumed silica is an example of such a filler. Some of the foregoing fillers may also impart color to the polymer. Examples of these include titanium dioxide, iron oxide, chromium oxide and carbon black. Other colorants such as azo/diazo dyes, phthalocyanines and dioxazines also can be used.

Reinforcing agents may also be present. The reinforcing agents take the form of particles and/or fibers that have an aspect ratio (ratio of longest dimension to shortest dimension) of at least 3, preferably at least 10. Examples of reinforcing agents include mica flakes, fiber glass, carbon fibers, boron or other ceramic fibers, metal fibers, flaked glass and the like. Reinforcing agents may be formed into mats or other preformed masses.

The reaction mixture is formed by mixing the polyisocyanate(s), polyether polyol(s), chelating agent(s) and optional ingredients, if any. If desired, all ingredients except the polyisocyanate may be formulated into a formulated polyol composition, which is subsequently combined with the polyisocyanate(s) to form the reaction mixture that reacts to produce the polyurethane. Alternatively, the various ingredients can all be combined at once or in any other arbitrary order, it being generally preferred to add the polyisocyanate(s) last or at the same time as the other ingredients are combined. The various components may be formed into various subcombinations that are subsequently combined with the other ingredients to produce the reaction mixture.

The isocyanate index may be, for example, at least 50 or at least 70 and up to 1000 or more. When producing flexible polyurethane foam, the isocyanate index may be 50 to 150, 60 to 130 or 70 to 125, for example.

The reaction mixture is cured to form the polyurethane. Generally, no special conditions are necessary. Therefore, processing conditions and equipment as previously described in the art for making polyurethanes are entirely suitable. In general, the isocyanate compounds will react spontaneously with the polyether polyols (component b) and water if present in the presence of the urethane catalyst even at room temperature (25° C.). If necessary, heat can be applied to the reaction mixture to speed the curing reaction. This can be done by heating some or all of the ingredients prior to combining them, by applying heat to the reaction mixture, or some combination of each. This heating can be at least partially due to the exothermic heat of reaction that is released as the reaction mixture cures.

In some embodiments, the curing step is performed in a closed mold. In such a process, the reaction mixture is either formed in the mold itself or formed outside the mold and then injected into the mold, where it cures. The shape and geometry of the molded part is constrained and defined by the internal surfaces of the mold.

In other embodiments, the curing step is performed in a free-rise (or slabstock) process, to produce a polyurethane foam. A blowing agent is present in the reaction mixture in such a process. In the free-rise process, the reaction mixture is poured into an open container such that expansion in at least one direction (usually the vertical direction) occurs against the atmosphere or a lightweight surface (such as a film) that provides negligible resistance to the expansion of the foam. The free-rise process may be performed by forming the reaction mixture and dispensing it into a trough or onto a conveyor where it expands and cures.

A polyurethane made in accordance with the invention may exhibit reduced cobalt extractables compared with an otherwise like foam made without the chelating agent. Cobalt extractables may be reduced by 2% or more. Cobalt extractables are determined by extracting cobalt according to the CertiPUR-US® Technical Guidelines (v. Oct. 25, 2016). The amount of extracted cobalt is then quantified by ICP-MS (inductively-coupled plasma-mass spectrometry). Samples are cut into small cubes (approximately 5 mm×5 mm×5 mm) and placed into a 33 mm PTFE screw cap 1 oz glass bottle that has been pre-rinsed with deionized water and dried. To each sample, 10-mL of an artificial perspiration (sweat) solution (Pickering Laboratories, Mountain View, CA; Cat #1700-0507) is added. The sample bottles are capped and placed into a water bath shaker set to 40° C. and shaken and heated for 8 hours. The samples are removed from the water bath and approximately 6 mL of the extract solution transferred from the bottles into 15-mL polypropylene test tubes. The extract solutions are prepared for analysis by taking a 0.5-mL aliquot of each and adding 4.5 mL of 5% nitric acid, to form a 10-fold dilution. The prepared solutions are then transferred into 3-mL autosampler vials for ICP-MS analysis.

The prepared solutions are analyzed using inductively coupled plasma mass spectrometry (ICP-MS) using an Agilent 7900x instrument calibrated over the range of 0-10 ng/mL using 0, 0.5, 1.0, 5.0 and 10 ng/mL calibration standards (SPEX CertiPrep, Multi-element Standards) made up in 5% nitric acid. The cobalt-59 isotope is monitored in no gas mode. The results obtained are calculated based on the dilution, mass of sample taken and the sample extract volume and are expressed as micrograms/gram (ug/g) or ppm.

Polyurethanes made in accordance with the invention are useful in a wide range of applications, as are conventional polyurethanes. Their reduced cobalt extractables renders them of particular interest in applications in which the polyurethane is subjected to aqueous fluids that can produce a leachate that comes into contact with animals (including humans), and/or which becomes released into the environment, in particular water sources such as municipal water systems and natural bodies of water. Among these are bedding and other human cushioning applications (pillows, mattresses, mattress toppers, seating cushions, automotive seating, etc.) that include a flexible polyurethane foam having an airflow of at least 0.8 L/s as measured according to ASTM D3574 Test G. In those applications, human bodily fluids such as sweat can leach cobalt from the polyurethane foam.

The following examples are provided to illustrate exemplary embodiments and are not intended to limit the scope thereof. All parts and percentages are by weight unless otherwise indicated.

In the following examples:

Polyol A is a random copolymer of propylene oxide and ethylene oxide having a hydroxyl number of 168. It is nominally trifunctional and is produced using a zinc hexacyanocobaltate catalyst complex, without removal of catalyst residues. Polyol A contains about 60% by weight oxyethylene units.

Polyol B is a random copolymer of propylene oxide and ethylene oxide having a hydroxyl number of 54. It is nominally trifunctional and is produced using a zinc hexacyanocobaltate catalyst complex, without removal of catalyst residues. It contains about 12% by weight oxyethylene units.

Polyol C is a polymer of propylene oxide having a hydroxyl number of 167. It is nominally trifunctional and is produced using a zinc hexacyanocobaltate catalyst complex, without removal of catalyst residues.

PMDI is a polymeric MDI having an average isocyanate functionality of 2.2 to 2.3 and an NCO content of 32.1 to 33.3% by weight.

The Catalyst is a mixture of a tin carboxylate, triethylene diamine and N,N,N′,N′-tetramethyl-2,2′-oxybis(ethylamine).

All Examples and Comparative Samples are made using a base recipe as set forth in Table 1. All ingredients except the PMDI are combined at room temperature (about 23° C.) using a laboratory mixer, followed by adding the PMDI. About 2100 g of the resulting curable reaction mixture is poured into a wooden box (38 cm×38 cm×24 cm) with an open top where it spontaneously cures to produce a flexible polyurethane foam. After curing, external skins are removed prior to testing.

TABLE 1
Base Curable Reaction Mixture

| Ingredient | Parts by Weight (Index) |
|---|---|
| Polyol A | 60 |
| Polyol B | 20 |
| Polyol C | 20 |
| Water | 2.2 |
| Silicone Surfactant | 0.8 |
| Catalyst | 0.3 |
| Chelating Agent | As indicated below |
| PMDI | 50 (78 index) |

### EXAMPLES 1-2 AND COMPARATIVE SAMPLES A-E

Foams are made using the base curable reaction mixture and either no chelating agent (Comp. Sample A) or a trisodium salt of N-(hydroxyethyl) ethylene diamine triacetic acid) (HEEDTA) in various amounts (Ex. 1 and 2 and Comp. Samples B-E). This chelating agent is provided in the form of an aqueous solution containing about 40% active material. The foams are tested as described before for cobalt extractables. Results are as indicated in Table 2.

TABLE 2

| | | | Cobalt Extractables |
|---|---|---|---|
| Designation | Chelating Agent | Amount¹ | (ppm) |
| A* | None | None | 1.49 |
| B* | HEEDTA | 0.02 | 1.86 |
| 1 | HEEDTA | 0.04 | 1.25 |
| 2 | HEEDTA | 0.08 | 1.46 |
| C* | HEEDTA | 0.12 | 1.63 |
| D* | HEEDTA | 0.16 | 2.15 |
| E* | HEEDTA | 0.2 | 2.95 |

*Comparative.
¹Active material, parts by weight per 100 parts combined weight of Polyols A, B and C. A negligible amount of water is provided with the chelating agent.

As the data in Table 2 shows, incorporating HEEDTA into the curable reaction mixture at certain amounts results in a significant decrease in cobalt extractables. With this particular chelating agent, this benefit is seen when somewhat more than 0.02 part, up to about 0.1 part is included per 100 parts by weight polyol. Surprisingly, both lower and higher amounts of the chelating agent lead to large increases in cobalt extractables.

### EXAMPLES 3-5 AND COMPARATIVE SAMPLES F-H

Foams are made using the base curable reaction mixture and various amounts of ethylene diamine tetraacetic acid tetrasodium salt (EDTA). This chelating agent is provided in the form of an aqueous solution containing about 40% active material. The foams are tested as described before for cobalt extractables. Results are as indicated in Table 3. The results for Comparative Sample A are reported again for comparison purposes.

TABLE 3

| | | | Cobalt Extractables |
|---|---|---|---|
| Designation | Chelating Agent | Amount¹ | (ppm) |
| A* | None | None | 1.49 |
| 3 | EDTA | 0.02 | 1.36 |
| 4 | EDTA | 0.04 | 1.36 |
| 5 | EDTA | 0.08 | 1.33 |
| F* | EDTA | 0.12 | 1.84 |
| G* | EDTA | 0.16 | 3.18 |
| H* | EDTA | 0.2 | 2.24 |

*Comparative.
¹Active material, parts by weight per 100 parts combined weight of Polyols A, B and C. A negligible amount of water is provided with the chelating agent.

Foams made using EDTA follow a similar trend as those made using HEEDTA. EDTA provides benefits over a slightly wider range of amounts. As with HEEDTA, higher amounts of the chelating agent lead to large increases in cobalt extractables.

### EXAMPLE 6 AND COMPARATIVE SAMPLES I-L

Foams are made using the base curable reaction mixture with various polymers or copolymers of acrylic acid. The foams are tested as described before for cobalt extractables. Results are as indicated in Table 4. The results for Comparative Sample A are reported again for comparison purposes.

TABLE 4

| | | | Cobalt |
|---|---|---|---|
| | | | Extractables |
| Designation | Chelating Agent | Amount | (ppm) |
| A* | None | None | 1.49 |
| 6 | 2500 Mₙ Poly(acrylic acid), | 0.1 | 1.42 |
| | NH₄ salt | | |
| I* | 2500 Mₙ Poly(acrylic acid), | 0.5 | 1.53 |
| | NH₄ salt | | |
| J* | 4000 Mₙ poly(acrylic acid-co- | 0.1 | 1.53 |
| | methacrylic acid)(80/20), | | |
| | sodium salt | | |
| K* | 6500 Mₙ Poly(acrylic acid), | 0.08 | 1.64 |
| | sodium salt | | |
| L* | 6500 Mₙ Poly(acrylic acid), | 0.12 | 1.64 |
| | sodium salt | | |

*Comparative.

Example 6 and Comparative Sample I again demonstrate the concentration effect associated with the chelating agent. A small amount of polyacrylic acid reduces cobalt extractables, whereas larger amounts increase them. Example 6 and Comparative Samples J, K and L demonstrate a molecular weight effect. Increasing the molecular weight of these polymeric chelating agents causes a deterioration in performance, with a worsening of cobalt extractables compared to the control.

### COMPARATIVE SAMPLES M-O

Foams are made using the base curable reaction mixture with various different chelating agents, as indicated in Table 5. The foams are tested as described before for cobalt extractables. Results are as indicated in Table 5. The results for Comparative Sample A are reported again for comparison purposes.

TABLE 5

| | | | Cobalt |
|---|---|---|---|
| | | | Extractables |
| Designation | Chelating Agent | Amount | (ppm) |
| A* | None | None | 1.49 |
| M* | Sodium oxalate | 0.1 | 1.53 |
| N* | Cetyl Trimethyl | 0.1 | 1.70 |
| | Ammonium Bromide | | |
| O* | Tris(2-Pyridylmethyl) Amine | 0.1 | 2.31 |

*Comparative.

These chelating agents all are found to increase cobalt extractables, further indicating that the beneficial effect of adding chelating agents is seen only with specific types.

1. A method of producing a polyurethane, comprising the steps of
(I) forming a curable reaction mixture by combining ingredients comprising a) at least one polyisocyanate, b) a polyether polyol having a hydroxyl number of at most 250 mg KOH/g or a mixture of two or more polyether polyols each having a hydroxyl number of at most 250 mg KOH/g, wherein the polyether polyol or mixture of polyether polyols contains metal-containing residues of a zinc hexacyanocobaltate catalyst complex and c) 0.02 to 0.1 part by weight, per 100 parts by weight of b), of a chelating agent having a number average molecular weight of at most 3000 g/mol and at least two carboxylic acid groups and/or carboxylate groups, wherein the carboxylate group(s) are associated with a monovalent anion, and the carbonyl carbon atom of each carboxylic acid group and/or carboxylate group is not bonded directly to the carbonyl carbon atom of another carboxylic acid or carboxylate group and
(II) curing the curable reaction mixture to produce the polyurethane.

2. The method of claim 1 wherein in step (I) the ingredients further comprise at least one blowing agent, and the polyurethane is a flexible polyurethane foam having an airflow of at least 0.8 L/s as measured according to ASTM D3574 test G.

3. The method of claim 2 wherein the at least one blowing agent includes water.

4. The method of claim 2 wherein in step (I) the ingredients further comprise at least one surfactant and at least one urethane catalyst.

5. The method of claim 2 wherein the chelating agent contains at least N—CH₂—C(O)OH or N—CH₂—C(O)O⁻M⁺ unit, where the nitrogen is an amino or imino nitrogen.

6. The method of claim 5 wherein the chelating agent includes at least one H—O(O)C—CH₂—NR—CH₂—C(O)O—H, H—O(O)C—CH₂—NR—CH₂—C(O)⁻M⁺ and/or M⁺⁻O(O)C—CH₂—NR—CH₂—C(O)⁻M⁺ structure where R is an aliphatic group that may be substituted or unsubstituted, and saturated or unsaturated.

7. The method of claim 2 wherein the chelating agent is selected from the group consisting of ethylenediamine tetraacetic acid, N-hydroxyethyl ethylenediamine N,N′,N′-triacetic acid; 1,2-bis(o-aminophenoxy)ethane-N,N,N′,N′-tetracetic acid, tetraxetan, ethylene diamine-N,N′-bis(2-hydroxyphenylacetic acid), ethylene diamine-N,N′-disuccinic acid, egtazic acid, ethylene diamine N,N′-diacetic acid, glutamic acid, iminodiacetic acid, kainic acid, nitrilotriacetic acid and diethylene triamine pentaacetic acid, and partially or fully neutralized salts of any of the foregoing with a monovalent anion.

8. The method of claim 2 wherein the chelating agent is selected from the group consisting of homopolymers of acrylic acid, homopolymers of methacrylic acid, copolymers of acrylic acid and/or methacrylic acid and partially and fully neutralized salts of any of the foregoing with a monovalent anion.

9. The method of claim 2 wherein b) includes 10 to 100% by weight, based on the weight of b), of at least one random copolymer of propylene oxide and ethylene oxide having an oxyethylene content of 45 to 65% by weight made using a zinc hexacyanocobaltate catalyst complex and containing cobalt-containing residues of the zinc hexacyanocobaltate catalyst complex.

10. A polyurethane made according to the method of claim 1.
